(19) United States
(12) Patent Application Publication
(10) Pub. No.: US 2011/0236204 A1
(43) Pub. Date: Sep. 29, 2011

(54) METHOD OF MANUFACTURING ROTOR ASSEMBLY, ROTOR ASSEMBLY, AND TURBO COMPRESSOR

(76) Inventors: Kazuaki KURIHARA, Yokohama-shi (JP); Kentarou ODA, Yokohama-shi (JP); Noriyasu SUGITANI, Yokohama-shi (JP); Minoru TSUKAMOTO, Yokohama-shi (JP); Nobusada TAKAHARA, Kamiina-gun (JP)

(21) Appl. No.: 13/072,917

(22) Filed: Mar. 28, 2011

(30) Foreign Application Priority Data
Mar. 29, 2010 (JP) P2010-074929

(51) Int. Cl. F01D 25/16; B23P 11/00

(52) U.S. Cl. 415/229; 29/889

(57) ABSTRACT

A method of manufacturing a rotor assembly in which a first impeller and a second impeller are fixed to a rotation shaft which is supported by a bearing so as to be rotatable, the method including: fixing the second impeller to the rotation shaft; fitting and fixing a sleeve to the rotation shaft after fixing the second impeller; fitting and fixing the bearing to the sleeve after fitting and fixing the sleeve; and fixing the first impeller after fitting and fixing the bearing.

### BACKGROUND OF THE INVENTION

1. Field of the Invention

The present invention relates to a method of manufacturing a rotor assembly, a rotor assembly, and a turbo compressor.

Priority is claimed on Japanese Patent Application No. 2010-074929, filed on Mar. 29, 2010, the content of which is incorporated herein by reference.

2. Description of Related Art

Typically, a turbo compressor that compresses and discharges a gas such as air or a refrigerant gas by rotating an impeller is known (for example, refer to Japanese Unexamined Patent Application, First Publication No. 2007-177695). The impeller is fixed to a rotation shaft, and the rotation shaft is supported by a bearing so as to be rotatable. The rotation shaft and the impeller are rotated by the rotating power of a predetermined driving device (a motor or the like), and as the impeller is rotated, the gas is sent to a diffuser formed at the periphery of the impeller to be compressed.

The impeller, the rotation shaft, and the bearing may be assembled into a rotor assembly before being built in the turbo compressor. In a turbo compressor having two compression stages as disclosed in Japanese Patent Application No. 2007-177695, two impellers are provided on both sides with a predetermined bearing interposed therebetween. In addition, on the opposite side of a rotation shaft to the side to which an impeller is fixed, a pinion gear is molded integrally with a rotation shaft main body. Accordingly, the rotor assembly may be assembled in the order of fitting the bearing to a supporting portion after passing one impeller through the supporting portion of the rotation shaft supported by the bearing and fixing the impeller thereto at a predetermined position.

However, when a long bearing life span needs to be ensured, for example, using a large bearing is considered. In order to use the large bearing, the rotation shaft needs to be of a thickness corresponding to the inside diameter of the bearing. However, as described above, during assembly of the rotor assembly, the one impeller is first passed through the supporting portion of the rotation shaft. Accordingly, it is difficult to use a thick rotation shaft, and thus it is difficult to ensure a long bearing life span using the large bearing.

In order to solve the problems, an object of the invention is to provide a method of manufacturing a rotor assembly, a rotor assembly, and a turbo compressor having the same, capable of ensuring a long bearing life span with the use of a large bearing.

In order to accomplish the object, the invention employs the following apparatus.

### SUMMARY OF THE INVENTION

According to a first aspect of the invention, there is provided a method of manufacturing a rotor assembly in which a first impeller and a second impeller are fixed to a rotation shaft which is supported by a bearing so as to be rotatable, the method including: fixing the second impeller to the rotation shaft; fitting and fixing a sleeve to the rotation shaft after fixing the second impeller; fitting and fixing the bearing to the sleeve after fitting and fixing the sleeve; and fixing the first impeller after fitting and fixing the bearing.

In the method of manufacturing a rotor assembly according to the first aspect of the invention, after fixing the second impeller to the rotation shaft, the sleeve is fitted and fixed to the rotation shaft, and the bearing is fitted and fixed to the sleeve. That is, instead of thickening the rotation shaft, the sleeve is used, so that it becomes possible to use a large bearing.

In addition, the method of manufacturing a rotor assembly according to a second aspect of the invention includes, before fitting and fixing the sleeve, adjusting the sleeve to an outside diameter measurement corresponding to a change in an outside diameter of the sleeve which is going to be caused while fitting and fixing the sleeve.

In the method of manufacturing a rotor assembly according to the second aspect of the invention, in the sleeve adjusting step, the sleeve is adjusted to the outside diameter measurement corresponding to the change in the outside diameter caused in the sleeve fixing step. Accordingly, there is no need to perform machining work on the outer peripheral surface of the sleeve in order to ensure a suitable interference between the sleeve and the bearing after the sleeve fixing step.

In addition, in the method of manufacturing a rotor assembly according to a third aspect of the invention, in adjusting the sleeve, the sleeve is adjusted to the outside diameter measurement obtained by subtracting the expansion amount of the outside diameter of the sleeve which is going to be caused while fitting and fixing the sleeve, from a predetermined outside diameter measurement.

According to a fourth aspect of the invention, there is provided a rotor assembly including: a rotation shaft supported by a bearing so as to be rotatable; two impellers fixed to the rotation shaft; and a sleeve which is fitted and fixed to the rotation shaft and is provided inside the bearing.

In the rotor assembly according to the fourth aspect of the invention, since the bearing is provided on the rotation shaft with the sleeve interposed therebetween, it becomes possible to use a large bearing without thickening the rotation shaft.

According to a fifth aspect of the invention, there is provided a turbo compressor which compresses a gas introduced from the outside so as to be discharged by rotating a rotor assembly including two impellers, and as the rotor assembly, the rotor assembly according to the fourth aspect is included.

According to the invention, the sleeve is provided on the rotation shaft, so that a large bearing can be used. Therefore, a long bearing life span can be ensured.

### BRIEF DESCRIPTION OF THE DRAWINGS

FIG. 1 is a horizontal cross-sectional view of a turbo compressor according to an embodiment of the invention.

FIG. 2 is a plan view of a rotor assembly according to the embodiment of the invention.

FIG. 3A is a schematic diagram of a sleeve according to the embodiment of the invention.

FIG. 3B is a schematic diagram of the sleeve according to the embodiment of the invention.

FIG. 4 is a horizontal enlarged cross-sectional view of a compressor unit and a gear unit according to the embodiment of the invention.

### DETAILED DESCRIPTION OF THE INVENTION

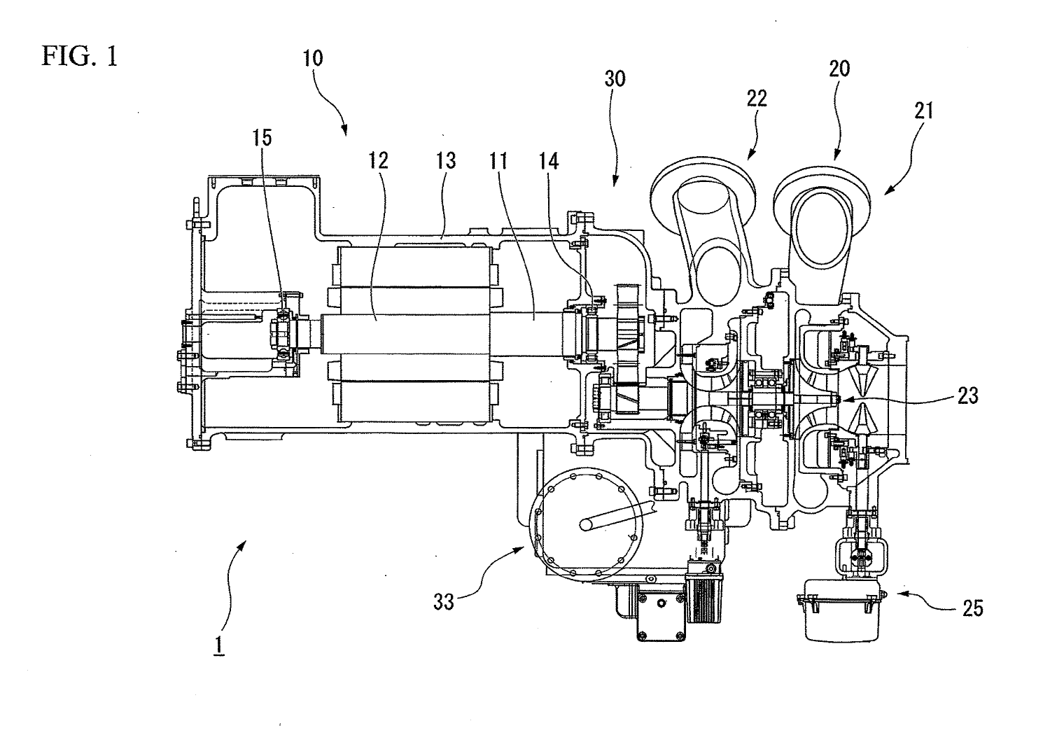

Hereinafter, exemplary embodiments of the invention will be described with reference to FIGS. 1 to 4. In addition, in the drawings used for the following description, in order to allow each member to have a recognizable size, the scale of each member is appropriately changed.

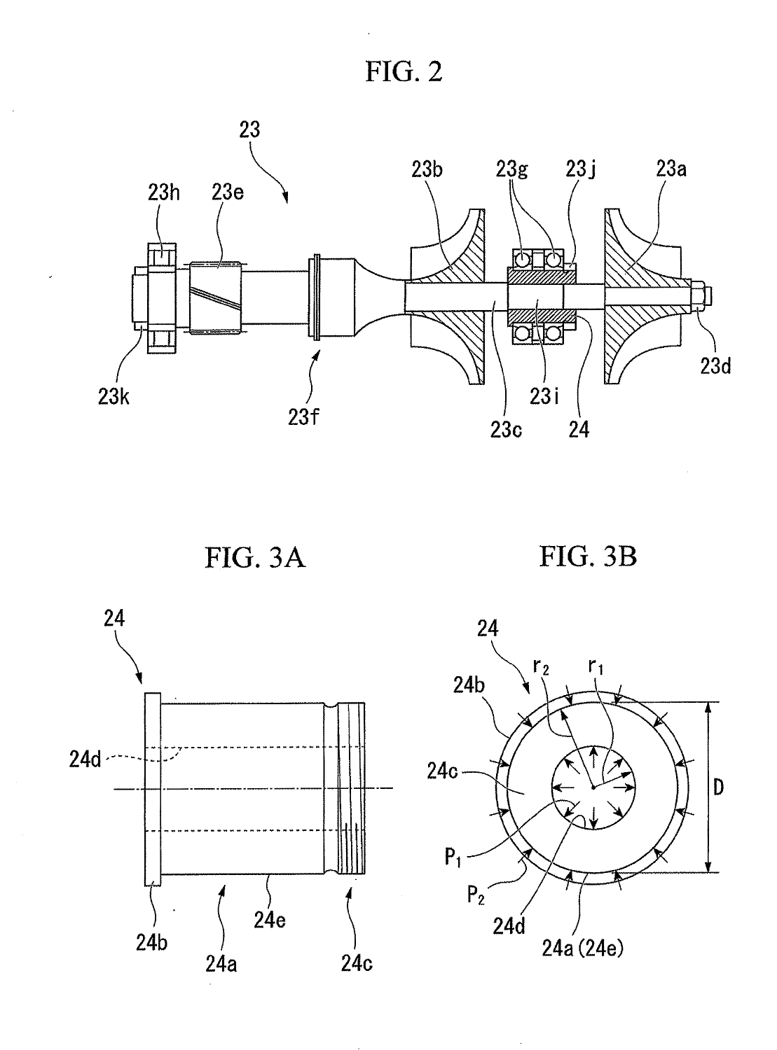

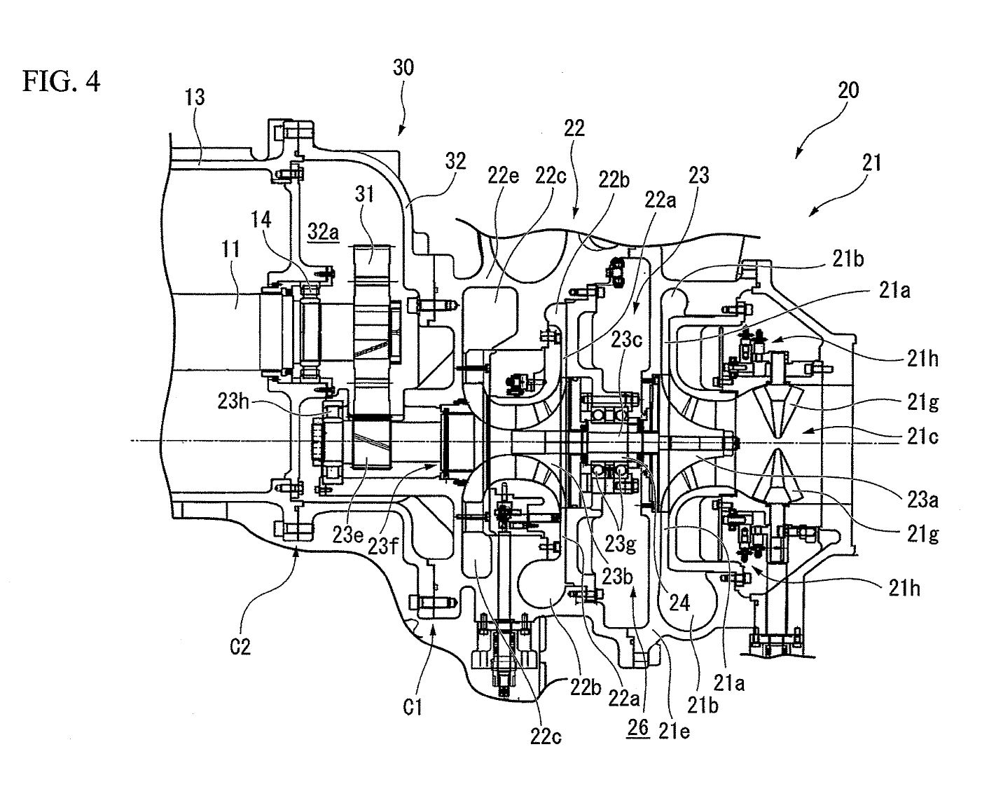

FIG. 1 is a horizontal cross-sectional view of a turbo compressor 1 according to this embodiment. In addition, FIG. 2 is a plan view of a rotor assembly 23 according to this embodiment. In addition, FIG. 3A is a plan view of a schematic diagram of a sleeve 24 according to this embodiment. FIG. 3B is a front view of the schematic diagram of the sleeve 24 according to this embodiment. In addition, FIG. 4 is a horizontal enlarged cross-sectional view of a compressor unit 20 and a gear unit 30 included in the turbo compressor 1 according to this embodiment.

The turbo compressor 1 according to this embodiment is used in a turbo refrigerator (not shown) provided in a building, a factory, or the like to generate air-conditioning cooling water, and compresses and discharges a refrigerant gas introduced from an evaporator (not shown) of the turbo refrigerator. As shown in FIG. 1, the turbo compressor 1 includes a motor unit 10, a compressor unit 20, and a gear unit 30.

The motor unit 10 has an output shaft 11 and includes a motor 12 which generates rotating power to drive the compressor unit 20 and a motor casing 13 which encloses the motor 12 and in which the motor 12 is provided. In addition, a driving unit that drives the compressor unit 20 is not limited to the motor 12, and for example, may also be an internal combustion engine.

The output shaft 11 of the motor 12 is supported so as to be rotatable by a first bearing 14 and a second bearing 15 which are fixed to the motor casing 13.

The compressor unit 20 includes a first compression stage 21 that intakes and compresses the refrigerant gas and a second compression stage 22 that further compresses the refrigerant gas compressed by the first compression stage 21 to be discharged as a compressed refrigerant gas. In addition, inside the compressor unit 20, a rotor assembly 23 that is provided in both the first and second compression stages 21 and 22 is provided.

The configuration of the rotor assembly 23 which is a feature of the turbo compressor 1 will be described. As shown in FIG. 2, in the rotor assembly 23, a first impeller 23a and a second impeller (impeller) 23b are fixed to a rotation shaft 23c extending in a predetermined direction (a direction in which the first and second compression stages 21 and 22 are opposed, see FIG. 1).

The first and second impellers 23a and 23b each have a configuration in which a plurality of blades are lined up in a peripheral direction on a peripheral surface of a substantially conical hub, and are fixed to the rotation shaft 23c so that their rear surface sides (bottom surface sides of the conical hubs) are in a posture opposed to each other. The first impeller 23a is fixed to one end side of the rotation shaft 23c using a nut 23d. The second impeller 23b is fixed to the substantially center portion of the rotation shaft 23c by shrink-fitting, press-fitting, or the like.

The rotation shaft 23c is, for example, a bar-shaped member molded of chrome molybdenum steel having high rigidity. A pinion gear 23e is molded on the opposite side of the rotation shaft 23c to a side to which the first impeller 23a is fixed. The pinion gear 23e is a gear for transmitting the rotating power of the motor 12 (see FIG. 1) to the first and second impellers 23a and 23b and is molded integrally with the rotation shaft 23c when the rotation shaft 23c is molded. Between the pinion gear 23e of the rotation shaft 23c and the second impeller 23b, a labyrinth seal 23f for preventing leakage of the refrigerant gas from the second compression stage 22 toward the gear unit 30 is provided. The labyrinth seal 23f surrounds the rotation shaft 23c and is fixed thereto by shrink-fitting, press-fitting, or the like. Moreover, similarly to the pinion gear 23e, the labyrinth seal 23f may also be molded integrally with the rotation shaft 23c when the rotation shaft 23c is molded.

In addition, the rotation shaft 23c is provided with a third bearing (bearing) 23g and a fourth bearing 23h. Both the third and fourth bearings 23g and 23h are rolling-element bearings and support the rotation shaft 23c so as to be rotatable.

The third bearing 23g is a bearing (a so-called angular bearing) capable of supporting loads in both the radial and thrust directions. The third bearing 23g is fixed to the rotation shaft 23c via a sleeve 24 between the first and second impellers 23a and 23b. The sleeve 24 is a member molded in a substantially cylindrical shape (see FIGS. 3A and 3B) and is fitted and fixed to a supporting portion 23i of the rotation shaft 23c between the first and second impellers 23a and 23b by shrink-fitting, press-fitting, or the like. Similarly, the third bearing 23g is fitted and fixed to the sleeve 24 by shrink-fitting, press-fitting, or the like. Since the sleeve 24 is provided between the rotation shaft 23c and the third bearing 23g, a large bearing can be used as the third bearing 23g without the use of a rotation shaft 23c having a large diameter. Moreover, in order to regulate movement of the third bearing 23g fitted to the sleeve 24 in an axial line direction of the rotation shaft 23c, the sleeve 24 is provided with a first snap ring 23j having an annular shape from the first impeller 23a side.

As shown in FIG. 3A, the sleeve 24 has a configuration in which a flange portion 24b is molded to widen from one end side of a cylindrical sleeve main body 24a in the diameter direction, and a male threaded portion 24c is formed on the other side. In addition, the sleeve 24 is molded using general carbon steel (ordinary steel). The flange portion 24b is a regulating portion for preventing the third bearing 23g fitted to the sleeve 24 from moving toward the second impeller 23b. The male threaded portion 24c is a portion to which the first snap ring 23j is mounted. To an inner peripheral surface 24d of the sleeve main body 24a, the supporting portion 23i of the rotation shaft 23c is fitted with a predetermined interference, and to the outer peripheral surface 24e of the sleeve main body 24a, the third bearing 23g is fitted with a predetermined interference (see FIG. 2).

As shown in FIG. 2, the fourth bearing 23h is fitted and fixed to the rotation shaft 23c on the opposite side to the labyrinth seal 23f with the pinion gear 23e interposed therebetween by shrink-fitting, press-fitting, or the like. Moreover, in order to regulate the movement of the fourth bearing 23h fitted to the rotation shaft 23c in the axial line direction of the rotation shaft 23c, a second snap ring 23k having an annular shape is provided in the rotation shaft 23c. The second snap ring 23k is mounted to a male threaded portion (not shown) formed on an end portion of the rotation shaft 23c.

Subsequently, the configurations of the first compression stage 21, the second compression stage 22, and the gear unit 30 are described.

As shown in FIG. 4, the first compression stage 21 includes a first diffuser 21a that compresses the refrigerant gas by converting the velocity energy of the refrigerant gas applied by the rotating first impeller 23a into pressure energy, a first scroll chamber 21b that leads the refrigerant gas compressed by the first diffuser 21a to the outside of the first compression stage 21, and an intake 21c that intakes the refrigerant gas to be supplied to the first impeller 23a.

Moreover, some portions of the first diffuser 21a, the first scroll chamber 21b, and the intake 21c are formed by a first impeller casing 21e that encloses the first impeller 23a.

In the intake 21c of the first compression stage 21, a plurality of inlet guide vanes 21g for controlling the intake capacity of the first compression stage 21 is installed.

Each of the inlet guide vanes 21g is rotated by a drive mechanism 21h fixed to the first impeller casing 21e so as to change the apparent area of the refrigerant gas from the upstream side of a flow direction. In addition, outside the first impeller casing 21e, a vane driving unit 25 (see FIG. 1) that rotates and drives each of the inlet guide vanes 21g connected to the drive mechanism 21h is installed.

The second compression stage 22 includes a second diffuser 22a that compresses the refrigerant gas by converting the velocity energy of the refrigerant gas applied by the rotating second impeller 23b into pressure energy so as to be discharged as the compressed refrigerant gas, a second scroll chamber 22b that leads the compressed refrigerant gas discharged from the second diffuser 22a to the outside of the second compression stage 22, and an introduction scroll chamber 22c that guides the refrigerant gas compressed by the first compression stage 21 to the second impeller 23b.

Moreover, the second diffuser 22a, the second scroll chamber 22b, and the introduction scroll chamber 22c are formed by a second impeller casing 22e that encloses the second impeller 23b.

The first scroll chamber 21b of the first compression stage 21 and the introduction scroll chamber 22c of the second compression stage 22 are connected via an external pipe (not shown) which is provided separately from the first and second compression stages 21 and 22 such that the refrigerant gas compressed by the first compression stage 21 is supplied to the second compression stage 22 via the external pipe.

The third bearing 23g of the rotor assembly 23 is fixed to the second impeller casing 22e in a space 26 between the first and second compression stages 21 and 22, and the fourth bearing 23h is fixed to the second impeller casing 22e on the gear unit 30 side. That is, the rotation shaft 23c of the rotor assembly 23 is supported inside the compressor unit 20 so as to be rotatable via the third and fourth bearings 23g and 23h.

The gear unit 30 includes a flat gear 31 which transmits the rotating power of the motor 12 to the rotation shaft 23c from the output shaft 11, and is fixed to the output shaft 11 of the motor 12 and is engaged with the pinion gear 23e of the rotation shaft 23c, and a gear casing 32 which accommodates the flat gear 31 and the pinion gear 23e.

The flat gear 31 has an outside diameter greater than that of the pinion gear 23e. As the flat gear 31 and the pinion gear 23e cooperate with each other, the rotating power of the motor 12 is transmitted to the rotation shaft 23c so that the number of rotation of the rotation shaft 23c becomes greater than that of the output shaft 11. Moreover, a transmission method is not limited to the above method, and the diameters of a plurality of gears may be set so that the number of the rotation shaft 23c is the same as or smaller than that of the output shaft 11. In order to ensure proper rotation of the flat gear 31 and the pinion gear 23e engaged with each other, the spacing therebetween is set to an appropriate value.

The gear casing 32 accommodates the flat gear 31 and the pinion gear 23e in an internal space 32a formed therein and are molded as a separate member from the motor casing 13 and the second impeller casing 22e so as to connect the motor casing 13 and the second impeller casing 22e. In addition, an oil tank 33 (see FIG. 1) that recovers and stores a lubricating oil supplied to sliding parts of the turbo compressor 1 is connected to the gear casing 32.

The gear casing 32 is connected to the second impeller casing 22e at a first connection portion C1, and is connected to the motor casing 13 at a second connection portion C2.

Next, a method of manufacturing the rotor assembly 23 according to this embodiment will be described. The description will be provided appropriately referring to FIGS. 2, 3A, 3B.

First, each of the first impeller 23a, the second impeller 23b, the rotation shaft 23c, the labyrinth seal 23f, and the sleeve 24 is manufactured by casting, machining work, or the like. Here, manufacturing of the sleeve 24 which is a feature of this embodiment will be described in detail.

As described above, the sleeve 24 is fitted and fixed to the supporting portion 23i of the rotation shaft 23c with a predetermined interference. Accordingly, when the sleeve 24 is fitted to the rotation shaft 23c, the sleeve main body 24a is biased outward from the rotation shaft 23c in the diameter direction, and the outer peripheral surface 24e thereof is swollen, so that the outside diameter D of the sleeve main body 24a expands. In addition, although the third bearing 23g is fitted and fixed to the outer peripheral surface 24e of the sleeve main body 24a, in order to prevent seizing or the like and ensure a long bearing life span of the third bearing 23g, the interference between the sleeve main body 24a and the third bearing 23g needs to be adjusted to a suitable value. That is, at the time of fitting the third bearing 23g to the sleeve main body 24a, the outside diameter D needs to be set to a suitable outside diameter measurement corresponding to the inside diameter of the third bearing 23g.

Here, in this embodiment, the sleeve 24 is manufactured according to the expansion of the outside diameter D of the sleeve main body 24a, which is going to be caused by fitting the sleeve 24 to the rotation shaft 23c. More specifically, so as to cause the outside diameter D to be the suitable outside diameter measurement corresponding to the inside diameter of the third bearing 23g by the expansion, during the manufacturing of the sleeve 24, the outside diameter D is set to a measurement obtained by subtracting the expansion amount of the outside diameter D from the suitable outside diameter measurement.

As a method of calculating the expansion amount of the outside diameter D when the sleeve 24 is fitted to the rotation shaft 23c, first, a first pressure P₁ exerted on the inner peripheral surface 24d of the sleeve main body 24a by the rotation shaft 23c when the sleeve 24 is fitted to the rotation shaft 23c with an interference δ in the radial direction is calculated, and the expansion amount of the outside diameter D of the sleeve main body 24a is calculated on the basis of the calculated first pressure P₁.

When the sleeve 24 is fitted to the rotation shaft 23c with the interference 8 in the radial direction, the first pressure P₁ exerted on the inner peripheral surface 24d by the rotation shaft 23c is generally given by the following expression (1).

Here, E₁ is modulus of longitudinal elasticity of the rotation shaft 23c, ν₁ is Poisson's ratio of the rotation shaft 23c, E₂ is modulus of longitudinal elasticity of the sleeve 24, ν₂ is Poisson's ratio of the sleeve 24, r₁ is radius of the sleeve main body 24a on the inner peripheral surface 24d side, and r₂ is radius of the sleeve main body 24a on the outer peripheral surface 24e side.

P₁=(δ/r₁){1/[(r₂²+r₁²)/E₂(r₂²−r₁²)+ν₂/E₂−(ν₁−1)/E₁]} (1)

Next, on the basis of the calculated first pressure P₁ and a second pressure P₂ (in general, atmospheric pressure) exerted inward from the outer peripheral surface 24e of the sleeve main body 24a, a displacement u of the outer peripheral surface 24e of the sleeve main body 24a in the radial direction when the sleeve 24 is fitted to the rotation shaft 23c is calculated. The displacement u is generally given by the following expression (2).

$$u = \frac{\{ 2 {P}_{1} {r}_{1}^{2} {r}_{2}^{2} - {P}_{2} {r}_{2}^{2} [ ( 1 - {v}_{2} ) {r}_{2}^{2} + ( 1 + {v}_{2} ) {r}_{1}^{2} ] \}}{{E}_{2} ( {r}_{2}^{2} - {r}_{1}^{2} ) {r}_{2}} \qquad ( 2 )$$

Since the displacement u is a displacement in the radial direction, the expansion amount of the outside diameter D of the sleeve main body 24a becomes 2u. Therefore, the sleeve 24 is manufactured to have an outside diameter measurement obtained by subtracting the expansion amount 2u from the suitable outside diameter measurement corresponding to the inside diameter of the third bearing 23g. Moreover, after purchasing a sleeve molded substantially in a cylindrical shape in advance, only the outer peripheral surface of the sleeve may be adjusted to the outside diameter according to the expansion.

Subsequently, the rotor assembly 23 is assembled using the components each manufactured. First, after the labyrinth seal 23f is fixed to the rotation shaft 23c, the second impeller 23b is fitted and fixed to the rotation shaft 23c by shrink-fitting, press-fitting, or the like. The second impeller 23b is inserted from the opposite side to the side where the pinion gear 23e of the rotation shaft 23c is provided, is passed through the supporting portion 23i, and is fixed to a predetermined position.

Next, the sleeve 24 is fitted and fixed to the supporting portion 23i of the rotation shaft 23c by shrink-fitting, press-fitting, or the like.

Here, as the sleeve 24 is fitted to the rotation shaft 23c with the interference δ in the radial direction, the outside diameter D of the sleeve main body 24a expands after fixing the sleeve 24. Above all, as described above, during the manufacturing of the sleeve 24, the sleeve 24 is manufactured in advance to have the outside diameter obtained by subtracting the expansion amount 2u during fitting from the suitable outside diameter measurement corresponding to the inside diameter of the third bearing 23g. Accordingly, the outside diameter D of the sleeve main body 24a after fixing the sleeve 24 has the suitable outside diameter measurement corresponding to the inside diameter of the third bearing 23g. That is, after the sleeve 24 is fitted and fixed to the rotation shaft 23c, there is no need to adjust the outside diameter D of the sleeve main body 24a to the suitable outside diameter measurement by machining the outer peripheral surface 24e of the sleeve main body 24a. Therefore, there is no need to perform machining work again during assembly of the rotor assembly 23, and laboriousness and costs in manufacturing the rotor assembly 23 can be reduced.

Thereafter, the third bearing 23g is fitted and fixed to the sleeve 24 by shrink-fitting, press-fitting, or the like. Since the sleeve main body 24a has the suitable outside diameter measurement corresponding to the inside diameter of the third bearing 23g, the third bearing 23g can be used under a suitable use condition. As a result, the third bearing 23g can be used for a long time. In addition, since the rotor assembly 23 according to this embodiment has the configuration in which the sleeve 24 is interposed between the rotation shaft 23c and the third bearing 23g, a large bearing can be used as the third bearing 23g without the use of a rotation shaft 23c having a large diameter. Therefore, a long bearing life span can be ensured for the rotor assembly 23.

Moreover, the third bearing 23g is fixed to the sleeve 24, and the fourth bearing 23h is fitted and fixed to the rotation shaft 23c. Lastly, the first impeller 23a is fixed to the rotation shaft 23c using the nut 23d after the rotation shaft 23c is provided inside the compressor unit 20.

Here, the second impeller 23b may be fixed to the rotation shaft 23c before fitting the sleeve 24 to the rotation shaft 23c.

As such, the manufacturing operation of the rotor assembly 23 is ended.

Subsequently, operations of the turbo compressor 1 according to this embodiment will be described.

First, the rotating power of the motor 12 is transmitted to the rotation shaft 23c via the flat gear 31 and the pinion gear 23e, and thus the first and second impellers 23a and 23b of the compressor unit 20 are driven to rotate.

When the first impeller 23a is driven to rotate, the intake 21c of the first compression stage 21 is in a negative pressure state, so that the refrigerant gas flows into the first compression stage 21 via the intake 21c. The refrigerant gas flowing into the first compression stage 21 flows to the first impeller 23a in the thrust direction and is given velocity energy by the first impeller 23a so as to be discharged in the radial direction.

The refrigerant gas discharged from the first impeller 23a is compressed as its velocity energy is converted into pressure energy by the first diffuser 21a.

The refrigerant gas discharged from the first diffuser 21a is led to the outside of the first compression stage 21 via the first scroll chamber 21b.

In addition, the refrigerant gas led to the outside of the first compression stage 21 is supplied to the second compression stage 22 via the external pipe (not shown).

The refrigerant gas supplied to the second compression stage 22 flows into the second impeller 23b in the thrust direction via the introduction scroll chamber 22c and is discharged in the radial direction in which velocity energy is applied thereto by the second impeller 23b.

The refrigerant gas discharged from the second impeller 23b is further compressed as its velocity energy is converted into pressure energy by the second diffuser 22b to become the compressed refrigerant gas.

The compressed refrigerant gas discharged from the second diffuser 22b is led to the outside of the second compression stage 22 via the second scroll chamber 22b.

As such, the operations of the turbo compressor 1 are ended.

Therefore, according to this embodiment, the following advantages can be obtained.

According to this embodiment, since the sleeve 24 is provided between the rotation shaft 23c and the third bearing 23g, a large bearing can be used as the third bearing 23g. Therefore, there is an advantage that a long bearing life span can be ensured for the rotor assembly 2.

While the exemplary embodiments related to the invention have been described with reference to the accompanying drawings, it is needless to say that the invention is not limited to the embodiments. The shapes and combinations of the constituent members described in the above embodiments are only examples and can be modified in various manners depending on design requirements without departing from the scope of the invention.

For example, in this embodiment, the turbo compressor 1 is used in the turbo refrigerator (not shown). However, the invention is not limited thereto, and the turbo compressor 1 may also be used as a supercharger that supplies compressed air to an internal combustion engine.

What is claimed is:

1. A method of manufacturing a rotor assembly in which a first impeller and a second impeller are fixed to a rotation shaft which is supported by a bearing so as to be rotatable, the method comprising:
fixing the second impeller to the rotation shaft;
fitting and fixing a sleeve to the rotation shaft after fixing the second impeller;
fitting and fixing the bearing to the sleeve after fitting and fixing the sleeve; and
fixing the first impeller after fitting and fixing the bearing.

2. The method according to claim 1, further comprising, before fitting and fixing the sleeve, adjusting the sleeve to an outside diameter measurement corresponding to a change in an outside diameter of the sleeve which is going to be caused while fitting and fixing the sleeve.

3. The method according to claim 2, wherein, in adjusting the sleeve, the sleeve is adjusted to the outside diameter measurement obtained by subtracting an expansion amount of the outside diameter of the sleeve which is going to be caused while fitting and fixing the sleeve, from a predetermined outside diameter measurement.

4. A rotor assembly comprising:
a rotation shaft supported by a bearing so as to be rotatable;
an impeller fixed to the rotation shaft; and
a sleeve which is fitted and fixed to the rotation shaft and is provided inside the bearing.

5. A turbo compressor which compresses a gas introduced from the outside so as to be discharged by rotating a rotor assembly including an impeller,
wherein, as the rotor assembly, the rotor assembly according to the claim 4 is included.
